(19) United States
(12) Patent Application Publication
(10) Pub. No.: US 2016/0314696 A1
(43) Pub. Date: Oct. 27, 2016

(54) A Method and System for Monitoring Behaviour

(71) Applicant: SOUTH AUSTRALIAN TECHNOLOGY GROUP PTY LIMITED, Woodville North, South Australia (AU)

(72) Inventors: Robin Hammond, Woodville North (AU); Guy Fens, Woodville North (AU)

(21) Appl. No.: 15/106,080

(22) PCT Filed: Dec. 18, 2014
(86) PCT No.: PCT/AU2014/001144

§ 371 Date: Jun. 17, 2016

(30) Foreign Application Priority Data
Dec. 19, 2013 (AU) 2013904964

(51) Int. Cl. G09B 5/02; G09B 19/00

(52) U.S. Cl. CPC G09B 5/02; G09B 19/00

(57) ABSTRACT

A method of monitoring behaviour of a first user in a group of users, the behaviour including the first user completing one or more tasks over time in accordance with one or more predetermined criteria associated therewith, the method including: receiving evidentiary information that the one or more tasks have been completed by the first user; sending a notification to a second user in the group of users that the one or more tasks have been completed by the first user; the second user providing a validation that the one or more tasks have been completed in accordance with the one or more predetermined criteria associated therewith based on the evidentiary information; receiving the validation; and providing an indication of the behaviour for display on respective selected user interfaces of the group of the users including the first user based on ones of the validation that the one or more tasks have been completed by the first user over time.

### TECHNICAL FIELD

The invention relates to a method and system for monitoring behaviour of a first user in a group of users (e.g. an organisation). In particular, the behaviour includes the first user completing one or more tasks in accordance with one or more predetermined criteria associated therewith.

In particular, but not exclusively, the method includes receiving a validation from a second user that the one or more tasks have been completed in accordance with the predetermined criteria based on evidentiary information provided by the first user, and providing an indication of the behaviour for display to the selected users based on received validations that the tasks have been completed by the first user over time so that the first user can develop their behaviour for, say, a particular role in their employment in the organisation.

### BACKGROUND ART

Any reference herein to prior art is not intended to imply that such prior art forms or formed a part of the common general knowledge in Australia or any other country.

Presently, there are many training courses and the like, whether internal or external to an organisation, which can teach or coach people to perform certain tasks within their roles in an organisation.

However, training courses are typically costly and if the material covered in the course is not used, then the material is usually not retained by the trainee or employee of the organisation.

Furthermore, training does not often transpire to behaviours in a role being completed as required. Additionally, management may not discover that a particular task has not been completed as required until it is too late, which can have detrimental results for certain processes/projects within an organisation.

### SUMMARY OF INVENTION

Accordingly, one aspect of the present invention provides a method of monitoring behaviour of a first user in a group of users, the behaviour including the first user completing one or more tasks over time in accordance with one or more predetermined criteria associated therewith, the method including:

receiving, at a main processing system, evidentiary information that the one or more tasks have been completed by the first user from a first user processing system associated with the first user in data communication with the main processing system;

the main processing system sending a notification to a second user in the group of users, having a second user processing system in data communication with the main processing system, that the one or more tasks have been completed by the first user;

the second user providing a validation that the one or more tasks have been completed in accordance with the one or more predetermined criteria associated therewith based on the evidentiary information;

receiving the validation from the second user processing system; and

the main processing system providing an indication of the behaviour for display on respective selected user interfaces of the group of the users including the first user based on ones of the validation that the one or more tasks have been completed by the first user over time.

Preferably, the first user is an employee in the group of users, and the second user is a manager of the employee in the group of users. More preferably, the group of users is an organisation. For example, the first user is an employee of the organisation, the second user is a manager of the employee, and the behaviour is a requirement of a role of the employee in the organisation. In another example, the second user is an internal or external recipient of a service associated with a task completed by the first user in the organisation (e.g. customer of the organisation). Also, it will be appreciated by those persons skilled in the art that the predetermined criteria are predetermined according to the role of the employee.

With reference to the example, the organisation is a bottling plant and the role of the employee is to accurately label bottles. That is, the behaviour to be monitored is the employee's accuracy of labelling bottles, which includes the tasks of, firstly, setting up the labelling operation in line with a specification and then labelling bottles. The predetermined criteria associated with the task of setting up the labelling operation includes: obtaining the correct labels for affixing to the bottles, obtaining correct bottles, obtaining packing details, etc. Evidentiary information in the form of an image of at least the obtained labels is sent to the main processing system and the main processing system sends a notification to a manager of the employee in the bottling plant that the task of setting up the labelling process in line with the specification has been completed diligently and satisfactorily by the employee. The manager reviews the image and, if the labels in the image are correct, the manager provides a validation that the task has been completed. The main processing system then receives the validation and provides an indication of the behaviour for display to, say, the employee based on validations that the setting up of the labelling process has been completed satisfactorily over time. Accordingly, in this example, the method enables mistakes in the labelling process to be identified by the manager and rectified before the employee moves on to the next task in the employee's role of labelling bottles.

Accordingly, the employee can also track their own progress in the satisfactory completion of tasks and though this consistent behaviour can improve their accuracy over time by proving to continuously behave dilligently. In another application, a further user in the organisation, such as a CEO, can monitor the progress of each of the employees in developing certain behaviours. That is, the indication of the behaviour for display on a user interface of the manager, or the CEO, includes providing ones of the indication of the behaviour of ones of the employee in the group of users over time.

In an embodiment, the indication of behaviour includes display of a plurality of levels, each of the levels indicating a predetermined threshold value of receipt of said ones of the validation for a given period of time. For example, level one equates to one validation per day, level two equates to five validations per day, and level three equates to ten validations per day. Alternatively, the indication further includes display of a graph indicating receipt of the validations by the first user for a given period of time, over time.

In an embodiment, the indication for display on a user interface of the first user further includes display of a plurality of colours indicating a status of the validation. For example, the status includes: validated, not-validated, and redo the one or more tasks based on provided comments, and the indication displays the colour red for “not-validated”, amber for “redo”, and green for “validated”. Furthermore, the comments may be provided by the second user and include comments relating to assisting the first user in re-doing the tasks according to the predetermined criteria.

In another embodiment, the indication further includes display of a graph indicating receipt of the validations that the tasks have been completed by the first user compared with the notifications sent to the second user that the tasks have been completed by the first user. That is, the indication display a percentage of validations received for each task for display to the first user or, say, a supervisor.

Also, the method can provide a weighting for each of the validations based on the tasks that have been completed. For example, certain tasks carry greater weight, and the above levels indicate the predetermined threshold value of receipt of the validations for the given period of time according to the weighting of the validations, respectively. In addition, the method further includes determining, at the main processing system, a score for the behaviour of the first user indicative of receipt of the validations over the given period of time according to the weighting of the validations, respectively, and providing the score for display to users on their respective user interfaces. The method can further provide a benchmark score (e.g. a company or organisation benchmark score) for display to the group of users on the respective selected user interfaces in association with the score so that the users can benchmark their behaviour against the company benchmark.

In another embodiment, the method further includes the main processing system sending a notification to a third user (e.g. the CEO of the organisation) in the group of users having a third user processing system in data communication with the main processing system that the one or more tasks have been completed and have been validated by the second user. The third user then provides a non-validation if the one or more tasks have not been completed in accordance with the one or more predetermined criteria based on the evidentiary information. The non-validation is received from the third user processing system and the indication of the behaviour of the first user is updated based on ones of the non-validation that the one or more tasks have not been completed by the first user over time. That is, an incorrect validation can be un-validated by, say, a supervisor of the second user.

In another embodiment, the method further includes determining, at the main processing system, a time taken between sending the notification to the second user processing system and receiving the validation from the second user processing system and providing an indication of the time taken for display on a user interface of a third user (e.g. the CEO of the organisation) in the group of users having a third user processing system in data communication with the main processing system. That is, the CEO can monitor the behaviour of the manager of the first user in relation to their task of validating user tasks in a timely manner. Also, the second user may be automatically prompted if the validation is not received within the predetermined time period. Thus, not only may the correct behaviour of the first user be instilled, the method may promote preferred behaviour and timeliness from the second user. Also, the third user can be an administrator (examples of which include human resources officer, general manager, managing director) and may intervene by confirming correct validation of the second user, as above.

In another embodiment, the method can further include the main processing system sending the notification to a third user (e.g. another manager of the organisation) in the group of users if the main processing system does not receive the validation from the second user processing system (e.g. the first manager processing system) within a predetermined time. In this case, the main processing system provides a non-validation that the one or more tasks have not been completed by the first user if the second user and the third user do not provide validations in a predetermined time, respectively. For example, the first manger has 5 minutes to provide a validation that the user completed a task according to the predetermined criteria and, if the first manager fails to validate that the task has been completed, the main processing system notifies the second manager to provide their validation. If the second manager also fails to validate that the task has been complete with 5 minutes, the main processing system provides a non-validation that the task was not completed. Nonetheless, it will be appreciated by those persons skilled in the art that more than two mangers can be employed by the method to provide the validation in this embodiment.

In another embodiment, the method further includes verifying, at the main processing system, that the one or more tasks have been completed in accordance with the one or more predetermined criteria based on the evidentiary information, providing a verification that the one or more tasks have been completed, and then the main processing system sending the notification to the second user upon verification that the one or more tasks have been completed. In yet another embodiment, the method includes the first user providing an indication that the one or more tasks have been completed in addition to the evidentiary information. For example, the indication includes data indicative of a ‘yes’ that a task is complete. The evidentiary information preferably includes any one or a combination of: a time stamp, indicating a time of completion of the one or more tasks; one or more documents; and location information, indicating a location of the one or more tasks.

According to another aspect of the present invention, there is provided a system for monitoring behaviour of a first user in a group of users, the behaviour including the first user completing one or more tasks over time in accordance with one or more predetermined criteria associated therewith, the system including:

a first user processing system associated with the first user;

a second user processing system associated with a second user in the group of users; and

a main processing system in data communication with the first user processing system and the second user processing system over a network, wherein the main processing system is configured to:

receive evidentiary information that the one or more tasks have been completed by the first user from the first user processing system;

send a notification to the second user that the one or more tasks have been completed by the first user and the second user providing a validation that the one or more tasks have been completed in accordance with the one or more predetermined criteria associated therewith based on the evidentiary information;

receive the validation from the second user processing system; and

provide an indication of the behaviour for display on respective selected user interfaces of the group of the users including the first user based on ones of the validation that the one or more tasks have been completed by the first user over time.

Preferably, the indication of the behaviour is displayed on a first user interface of the first user processing system. In addition, the system preferably further includes a third user processing system associated with a third user in the group of users in data communication with the main processing system, and the indication of the behaviour is displayed on a third user interface of the third user processing system. Thus, as above, the first user can monitor their behaviour based on the indication displayed on their user interface and the third user (e.g. a CEO) can monitor the behaviour of all the first users (e.g. employees) of the organisation using their user interface. Furthermore, it will be appreciated by those persons skilled in the art that the above described manager can monitor their staff of first users (e.g. employees) of the organisation using their user interface.

According to another aspect of the present invention, there is provided a main processing system for monitoring behaviour of a first user in a group of users, the behaviour including the first user completing one or more tasks over time in accordance with one or more predetermined criteria associated therewith, the main processing system including:

a processor;

a data store including computer program code to be performed by the processor; and

a network interface for interfacing with a plurality of user processing systems associated with respective users in the group of users over a network, wherein the processor is configured to:

receive evidentiary information that the one or more tasks have been completed by the first user from a first user processing system associated with the first user in data communication with the main processing system over the network;

send a notification to a second user in the group of users, having a second user processing system in data communication with the main processing system over the network, that the one or more tasks have been completed by the first user and the second user providing a validation that the one or more tasks have been completed in accordance with the one or more predetermined criteria associated therewith based on the evidentiary information;

receive the validation from the second user processing system over the network; and

provide an indication of the behaviour for display on respective selected user interfaces of the group of the users including the first user based on ones of the validation that the one or more tasks have been completed by the first user over time.

According to another aspect of the present invention, there is provided a computer program for instructing a processor, which when executed by the processor, causes the processor to perform the above method.

According to another aspect of the present invention, there is provided a non-transitory processor readable tangible media including the above program which when executed by the processor causes the processor to perform the above method.

### BRIEF DESCRIPTION OF DRAWINGS

Embodiments of the present invention will now be described below with reference to the accompanying drawings, in which:

FIG. 1 is a flow diagram of a method of monitoring behaviour of a user according to an embodiment of the present invention;

FIG. 2 is a schematic of a system for monitoring behaviour of a user according to an embodiment of the present invention;

FIG. 3 is a flow diagram of an example of a validation process according to an embodiment of the present invention;

FIG. 4 is a further flow diagram of an example of the validation process according to an embodiment of the present invention;

FIG. 5 is a further flow diagram of an example of the validation process according to an embodiment of the present invention;

FIGS. 6A to 6F are images of an example mobile application giving effect to the method of FIG. 1 and the system of FIG. 2; and

FIG. 7 is a diagram of an example of a distributed system architecture implementing the system of FIG. 2.

### DESCRIPTION OF EMBODIMENTS

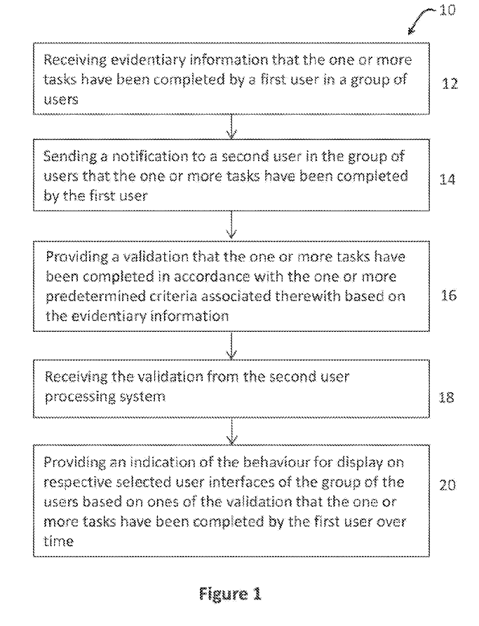

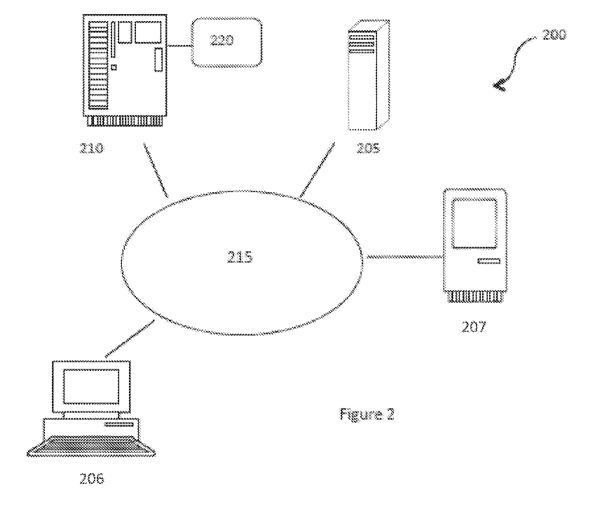

FIG. 1 shows a flow chart of a method 10 of monitoring behaviour of a first user in a group of users according to an embodiment of the present invention, and FIG. 2 shows a schematic of a system for monitoring behaviour of a first user according to an embodiment of the present invention. In an example, the organisation is a company and the first user is an employee of the company. In addition or in the alternative, the first user is a student or a volunteer of the organisation. Nonetheless, the behaviour includes the first user completing one or more tasks in accordance with one or more predetermined criteria associated therewith. For example, the behaviour is timeliness to produce a report, the task is producing and sending the document to a supervisor of the first user, and the predetermined criteria includes a minimum time taken to produce and send the document.

The method 10 includes the following steps to monitor the behaviour of the first user. Firstly, the method 10 includes receiving 12, at a main processing system (shown in FIG. 2), evidentiary information (e.g. a time stamp of completion of the report) that the one or more tasks have been completed by the first user from a first user processing system associated with the first user in data communication with the main processing system. In another embodiment, the method first receives a notification from the first user that the one or more tasks have been completed. This can include, for example, receiving an indication that a document has been sent and uploaded to the main processing system, or a report has been completed and uploaded, or a task has been checked as being completed, or the like. The method then includes the main processing system sending 14 notification to a second user in the group of users, having a second user processing system in data communication with the main processing system, that the one or more tasks have been completed by the first user. In another embodiment, the main processing system verifies that the one or more tasks have been completed in accordance with the one or more predetermined criteria based on the evidentiary information before sending the notification to the second user that the one or more tasks have been completed. In any event, the method includes the second user providing 16 a validation that the one or more tasks have been completed in accordance with the one or more predetermined criteria (e.g. minimum time to send the completed report) associated therewith based on the evidentiary information, the main processing system receiving 18 the validation from the second user processing system, and the main processing system providing 20 an indication of the behaviour for display on respective selected user interfaces of the group of the users including the first user based on ones of the validation that the one or more tasks have been completed by the first user over time. That is, for example, the first user can monitor their timeliness in producing reports over time and, hopefully, make improvements.

Thus, there is provided herein a system/method where a task can be verified and a behaviour can be validated by a second user (which is in this example is a manager in the form of a supervisor of the employee). It will be appreciated by those persons skilled in the art that in a group of users there will be multiple first users (employees) and multiple second users (managers). Also, as described, there will likely be a third group of users in form of administrators or CEO's that oversee all other users in the group. Examples of managers include but are not limited to a director, overseer, controller, superintendent, chief, head, steward, foreman and a boss, which can check to see whether evidentiary information (e.g. a report) has been submitted to the main processing system according to the predetermined criteria such as an agreed date/time. In this example, if the report has been received, it can then be verified and validated. If the manager then looks at the evidentiary data in the report and establishes that all areas were fully completed then this action can be validated, and the employee can in some cases be promoted to a new level.

Thus, the method and system described herein can include receiving evidentiary information together with the indication that the one or more tasks have been completed. In this but not all examples, the evidentiary information includes any one or a combination of: a time stamp in the form of digital time stamp information, indicating a time of completion, one or more documents in the form of digital document information, and/or location information (such as information received from a global positioning system or a time stamped photo, or the like) in the form of digital location information, indicating a location of where the task was completed. In this but not necessarily in all embodiments, the evidentiary information is in the form of digital evidentiary information for processing by the main processing system. The evidentiary information may be proof that the task was completed in accordance with the predetermined criteria. In the context of this embodiment, “digital information” is information that may generally be stored at and/or transmitted between the main processing system and the user processing systems. Digital information may generally be transmitted using ETHERNET, TCP/IP, USB, or generally any suitable protocol, and can be stored in volatile or non-volatile memory such as a register, RAM, FLASH memory, and a hard drive, for example.

FIG. 2 shows an embodiment of the system for monitoring behaviour including a distributed system 200, which may include a plurality of computer/processing systems 205/210, connected via a network 215. Network 215 may generally be any type of Internet, Intranet, WAN, LAN, or the like. Furthermore, computer/processing systems 205/210 can be any type of user processing system, server system, or the like.

In the example shown in FIG. 2, a first user in the group of users can access the system 200 for monitoring behaviour via the above main processing system in the form of a computer server 210 and via any form of first user processing system 205; for example, a personal computer in communication with the main processing system 210 and running appropriate interface software (for example, a web browser or X-windows). The main processing system 210 is, in this example, connected to or has a database or data store 220 for storing instructions in the form of a computer program for implementing the above method 10. It will be appreciated that the data store comprises any form of device/system which can store data and can include, for example, a cache, memory, data cloud, or the like, and generally but not necessarily includes associated software for managing the storage of the data. For example, the data store may include relational database structures stored on a local hard drive, for example relational database structures implemented using SQL or FILEMAKER.

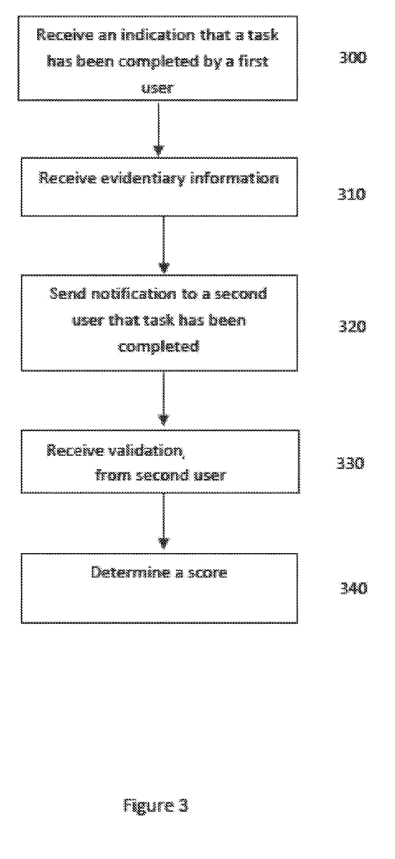

FIG. 3 shows a further example of the method 10 of monitoring of monitoring behaviour using the system 200 shown in FIG. 2. In FIG. 3, at step 300, the main processing system 210 receives an indication that a task has been completed by a first user. The indication can be received from the first user processing system 205. Thus, for example, the first user can download an application (for example, a mobile application (“app”) built using Android Studio, Android Software Development Kit “SDK” or APP INVENTOR, by Google Labs, for example) onto their user processing system 205 in the form of a mobile device which can access the main processing system 210 via the network 215. The indication that a task has been completed is, for instance, the user ticking a check box or selecting a “yes” or “no” option that the task has been completed using radio buttons in the application (or any other type of notification).

In yet another example, an indication that a task has been completed may include receiving a document in the form of digital document information, which forms the above mentioned evidentiary information. Thus, for example, if the task is to complete a report, then uploading evidentiary information in the form of the report to the main processing system 210 provides the indication that the task has been completed.

Turning back to the example shown in FIG. 3, at step 310, the processing system 210 receives the evidentiary information from the first user. As discussed, the evidentiary information can be any type of information which evidences or proves that the user has completed a task in accordance with predetermined criteria. Thus, for example, the first user can provide a date/time stamp indicating that the task has been completed via the first user processing system 205 so that, for example, if the first user is required to complete a report at a certain time or date, then the time or date that the report is uploaded or sent to the processing system 210 can provide evidence or proof that the report was completed on time. The digital time stamp information may also be generated by the main processing system 210.

At step 320, the main processing system 210 sends a notification to the second user, via a second user processing system 206, that the task has been completed. It will be appreciated that the notification can be sent via any means, such as message generated within a mobile application, or via electronic mail (Email), or a short message service (SMS) or pop-up screen to a desktop or dashboard user. Once the second user has received the notification that the task has been completed, the second user can provide their validation to the main processing system 210, as shown at step 330. Thus, for example, the second user can provide their validation by acknowledging that the task has been properly completed in accordance with predetermined criteria. In another example, the application resident on the first user processing system verifies that tasks have been completed according to the predetermined criteria and the manager/supervisor provides a validation that the task has been completed according to the predetermined criteria via the second user processing system.

In addition, as the second user can be the first user's manager or supervisor in the organisation, the second user's validation can be used to determined a score for the completed task, a shown at step 340 of FIG. 3. That is, in one embodiment, the main processing system 210 determines a score for the behaviour of the first user indicative of receipt of ones of the validation over a given period of time according to a weighting of the validations, respectively. The score is provided for display to the first user as well as other users with selected privilege, such as the manager and the supervisor on their respective user interfaces. Further, the main processing system 210 provides a benchmark score for display to the group of users on the respective selected user interfaces in association with the score. For example, the main processing system 210 determines the benchmark score based on an average of the first user's scores for completing a particular task. That is, the score provided can be determined in accordance with the task (e.g. the role, the type of employment, and the like). Thus, it will be appreciated that, for example, a number of first users in a business can start to compare their scores to a benchmark specific to the role so that they can be performance managed based on their scores, and can be promoted (or disciplined) based on their scores. Also, it will be appreciated that the roles can be reversed and an employee can provide a validation of a manager's task, and the main processing system 210 determines a score for the manager using the above method.

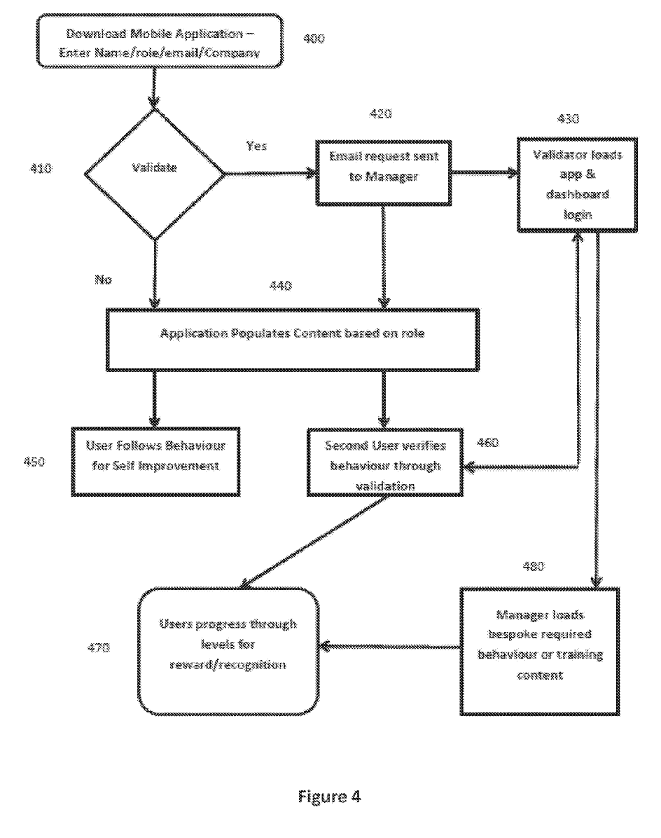

FIG. 4 shows another example of a method of monitoring behaviour. In the example of FIG. 4, at step 400, a mobile application resident on the first user processing system 205, which can allow a user access to the main processing system 120 implementing the method, can be downloaded by the first user onto their mobile device. The user enters their user details, such as their name, role, email and company in order to register/log into (or access) the main processing system 210 to implement the method.

At step 410, if the first user's task cannot validated, the application, at step 440, populates basic content depending on the predetermined criteria of the task (e.g. the role of the employee) to be displayed on the user interface of the mobile device, such as a number of predetermined criteria which have to be satisfied for a respective number of tasks in accordance with the user's role. At step 450, the first user can follow the required behaviour for their role in order to self-improve/self-train.

At step 410, if the first user's completed task can be validated, a notification, such as a system request, is sent to the first user's manager (second user) to validate the completion of the task. For example, the completion of the task is verified by the main processing system 210 and the email request is sent to the second user accordingly. At step 440, the application resident on the first user mobile device again populates the content based on the role as above. At step 430, an application resident of the second user device is loaded and displays a dashboard login for the second user (where the dashboard is another example implementation of a user interface). At step 460, the second user can then validate the first user completed their task according to the predetermined criteria and thus validate the task and the behaviour. In this particular example, at step 470, the first user can progress through predetermined levels for rewards/recognition and at 480 the manager (second user) can load tailored required behaviour or training content using their user interface of their user device consideration by the first user. That is, in an example, the employee can have a number of behaviours monitored using the method. These behaviours could be generic behaviours for particular roles of the employee or tailored behaviours created to meet the requirement of their role. For example, the method can provide a mechanism by which a task can be created and assigned for a particular role of a user in the group. Here, the creator of a task is typically the individual that also validates the behaviour. However, it may also be a user of the group of users that is responsible for creating tasks for a particular behaviour (e.g. employment role). That is, the employee's role may have a standard set of behaviours including standard tasks or it may have tailored, specific behaviours in line with an organisation's needs for that role.

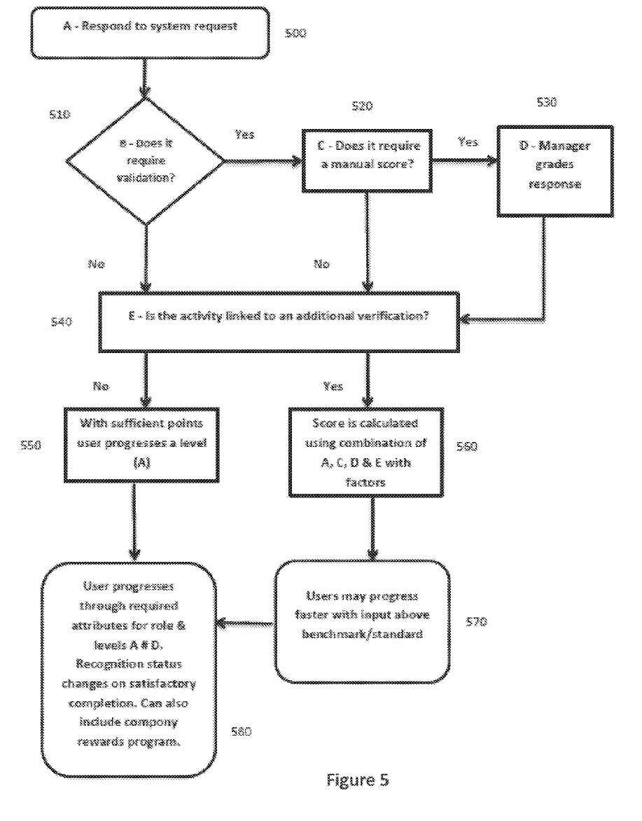

A further example of a method of monitoring behaviour is shown in FIG. 5. At step 500, a response (e.g. evidentiary information) is sent from the first user in response to a system request where a task is to be completed. At step 510, the main processing system 210 determines whether validation of the completed task is required by the second user. In this example, whether validation is required is dependent on the type of task to be completed. Simple requests (such as those requiring only yes/no responses) may not require validation but will appear on the second users' dashboard in the event that they do not correspond with the required response pre-programmed into the main processing system 210. This may be, for example, highlighted on the dashboard of the second user interface by amber or red lights, and notifications may be sent to the second user (e.g. manager) requesting investigation of the first users' action in relation to these tasks. In any event, if validation is required, the main processing system 210, at step 520, determines whether a manual score is required, and if so, the manager can provide a score for the response at step 530 to the main processing system 210 via network 215. If validation is not required, the main processing system 210, at step 540, determines whether the task (shown in this example as an activity) is linked to an additional verification.

At step 550, if the activity is not linked to other tasks, and if the first user has sufficient points from the second user provided score, the user can progress to another level. The first user can then further progress through required behaviours (e.g. attributes for their role) at step 580. The recognition status of the first user can also change on satisfactory completion of tasks and can also include a company rewards program. At step 560, if the activity is linked to other tasks then the user's score can be calculated based on a combination of factors including those at steps 500, 520, 530, and 540. At step 570, the first users are displayed a benchmark score for a behaviour so that they may progress faster. Progressing to levels for the first user as described herein may be equated to a promotion into a role of the first user, or can include virtual levels where a gamification of the presently described system and method can create a competition between users of the group.

Referring back to FIG. 2, in another embodiment, the main processing system 210 can determine if a received validation from the second user satisfies predetermined second user performance criteria. For example, the predetermined second user performance criteria includes the validation being received within a predetermined time period and the second user may be automatically prompted if the validation is not received within the predetermined period. Also, as described, the main processing system 210 can send a notification to a third user (e.g. administrator, such as a human resources officer, CEO, general manager, managing director, etc.) in the group of users having a third user processing system 207 in data communication with the main processing system that the one or more tasks have been completed and have been validated by the second user. The third user can provide a non-validation if the one or more tasks have not been completed in accordance with the one or more predetermined criteria based on the evidentiary information and the main processing system 210 receives the non-validation from the third user processing system 207 and updates the indication of the behaviour based on the non-validations that the tasks have not been completed by the first user over time. Accordingly, not only may the correct behaviour of the first user be instilled, the method and system may promote preferred behaviour and timeliness of the second user.

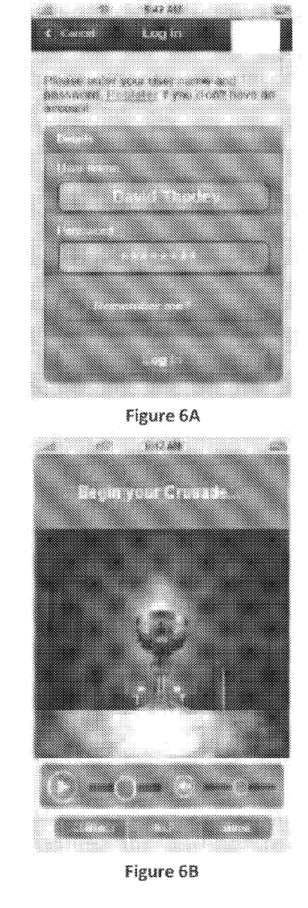

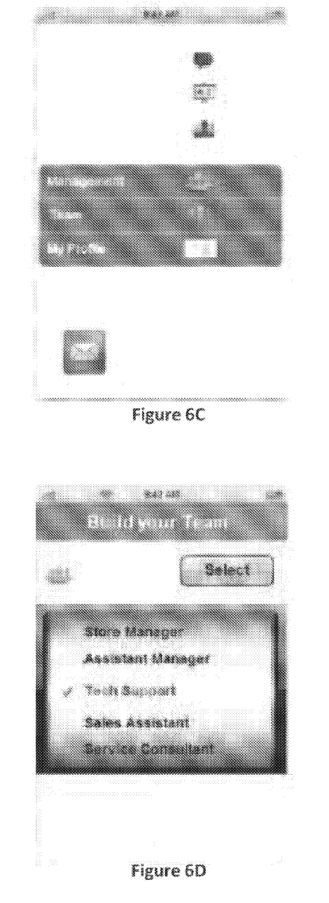

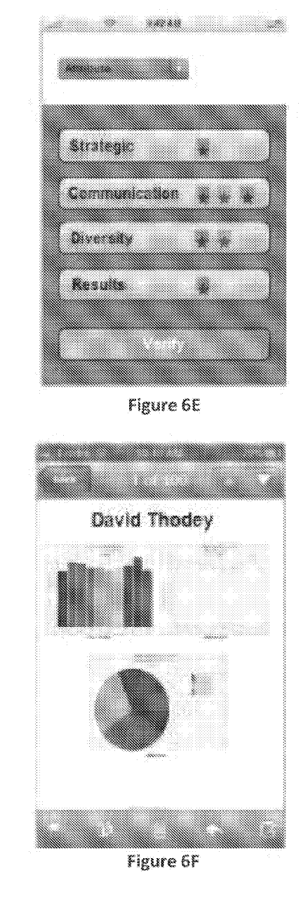

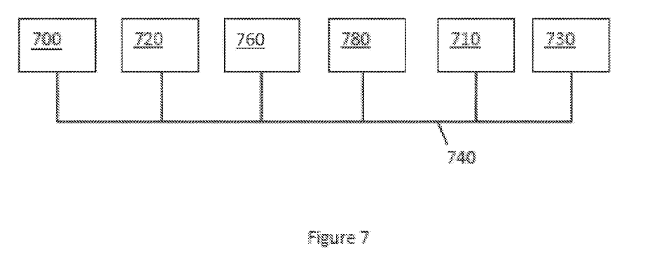

FIGS. 6A to 6F show examples of screenshots of a user interface implementing the system 200 of FIG. 2 an the method 10 of FIG. 1. Here, the first user, the second user and any other users have access to the system/method described herein via a mobile software application user interface resident on their user processing system. In this particular example, FIG. 6A shows an example of a user interface with an encrypted secure registration and login to the back end application or incumbent user data base 220 of the main processing system 210. For example, the user can then enter their industry, company and job role in the user interface and the main processing system 210 loads generic behaviours including tasks that the user is required to complete at key points in time (e.g. starting work, before/after meetings etc.), for their particular role.

FIG. 6B shows an example of tutorial instruction on the user interface at commencement of the application. FIG. 6C shows an example of a user interface of the first user, showing a mobile dashboard, visibility, chat, contact and message functions. FIG. 6D shows an example of an interface for the second user (e.g. a corporate view) which can be used to set up users of the group, where different roles have specific attributes related to their job function. FIG. 6E shows an example of a user interface for the first user where a user selects a behaviour (shown in this example as an attribute) and is given a behaviour prompt or instruction. In respect of this example, the user can select from a multiple choice response or manually enter text in relation to verifying and validating completed tasks for the displayed behaviours. The user may also be provided the option to self-administer the validation or to request to connect to a work colleague/manager to provide the validation. By connecting to a manager, the manager can then verify and/or validate completed tasks of the user in the above manner. That is, the main processing system 210 provides the user's response to their manager to validate the completed tasks. FIG. 6F shows an example first user interface (dashboard) with the ability to customise view by activity, group, attribute, reward, results, achievements, and the like, depending on the user. As described, the dashboard of the user interface can also allow for behaviours of a number of users to be displayed and compared. The method and system described herein can be implemented as an application on a mobile telecommunication device, tablet device, personal computing device or the like. All users can have access to synchronised data from the main processing system 210 that is seamlessly updated as required. The applications can be provided as a dashboard viewable by the employee and the manager, as well as higher managers such as a line management, and the like.

### FURTHER EXAMPLES

As described, it will be appreciated that the method 10 of monitoring behaviour described herein can be performed with a plurality of first users and a plurality of second users in the group of users, and which can additionally include a third user, such as a general manager or executive, or any number of users at different levels in group of users having an organisational hierarchy. It will also be appreciated that the presently described system and method can improve behaviour in the form of role specific business skills, characteristics and performance by validation and, in some cases, verification over a period to have an employee form habits for essential skills. Thus, employees can become higher calibre performers within a defined role. Thus, using the steps of verification and validation, the managers no longer need to depend on word of mouth or regular reviews to ascertain exactly how an employee is behaving and completing their tasks.

According to one particular example, behaviours can be drawn from a list with associated predetermined criteria, such as frequency of validations and time lines, created to suit appropriate behaviours to form habits to consistently improve for an employee in a role. Furthermore, it will also be appreciated that a user can self-validate initially or invite their manager/supervisor to validate the completed tasks on an ongoing basis. Thus, there can be provided a number of behaviours with different tasks and different validation methods, such as (and not limited to):
tailorable behaviours comprising tasks with yes no answers along with evidentiary information in the form of a time stamp
behaviours comprising tasks with score responses along with time stamp
behaviours comprising tasks with file upload capability along with time stamp
behaviours comprising tasks with GPS location validation along with time stamp
behaviours comprising tasks with time stamped photographic evidence

In addition, the system and method described herein can become a valuable addition to a human resources user (or the like) in monitoring whether individual employee's behaviours are consistent over a period of time or whether for example a drop in performance or compliance can be linked to other related behaviour such as tardiness or attitude problems. It will be appreciated that this can then provide a measurable example of the effect, which can point to issues potentially outside the working environment. Furthermore, the system/method described herein can thus be used to form habits for particular users by providing constant feedback. Thus, the system and method described herein can be agnostic to the learning style of an individual; thus gaining greater advantage from any training investment.

According to one specific example, if a manager wishes to view the progress of a user in the group of users, the manager registers to use the main processing system 210 so that the manager can then have access to a dashboard where they can see the progress of the user through multiple levels and also load tailored tasks in the form of attributes for the user to complete. According to another specific example, the presently described system and method can allow for particular training and learning to be retained by a user performing a certain role. Thus, for example, after a course, specific content can be provided to the system and method described herein. Accordingly, daily/weekly use can be validated by management which can instil and embed the requirements of an activity as a learning which can become a habit. Thus, the system and method described herein can become a personal guide to improve behaviours. Accordingly, confirmation (through validation) is provided of the user's behaviour.

Further, the system and method described herein can provide a platform and tools, which can allow employees to monitor and transform their behaviours and thus form habits as required by a business, and allow other departments of a business, such as human resources or the like, to monitor employees' behaviour. In a further example, if a manager has to role of coaching a team and failed to coach a team member appropriately, their failure to coach can be validated by a team member, which would highlight to the manager that they got a low score on coaching and need to make a change of their approach to assist in the planning and review after a meeting or a call. Besides driving change in the behaviours in line with company strategy or job functionality, the system and method described herein can monitor the progress made across a series of attributes forming the behaviour (examples of which are further provided below), which can also be represented in the gaming world as journeys, levels and crusades. This competition element means the users can track their progress, compete against themselves or their peers and the provided benchmark score. In this particular example, people who are good at a certain tasks often have attributes in common such as sales people being driven to achieving results. By understanding, the various attributes, it can make it easier to ensure that staff are suitable for the roles that they undertake.

Each user builds their own portfolio or passport of completion which could remain with them on a personal level or if they changed roles or manager. In this particular example, by demonstrating consistent behaviour and improvement in the behaviour, the user can progress up a level (for example, by being promoted). This could be represented by a star rating or category which could be published once awarded. In one particular example, publication of a user's achievement can happen on the company's intranet or on a social networking site, or the like. Additionally, many corporate organisations have an existing staff reward or recognition program which can be incorporated into the presently described system/method (such as, for example, through an application programming interface, or the like). If not in existence one can be created and built in to the company specific version of system/method described herein.

In another example, the system and method described herein can be integrated with other databases of an organisation, where user's information can be provided through the integration. Thus, it will be appreciated that the system and method described herein can make improvements across the workforce in every role rather than the usual improvement for a specific user group where training or incentive has been focussed. This can mean that an organisation may not need to spend additional funds to offer incentive recognised programs to gain from the workforce. The user is also recognised throughout the business on their performance.

Thus, the system and method described herein can provide management with full visibility throughout the journey of the users via dashboard interfaces of selected managers to also easily track activity, progress or even input tailored behavioural statements or requests that would need to be verified and validated upon completion. For example, the system administrator can set up users, groups and behaviours can be pre-populated in accordance with a specific role, as described. This can be further customised by selecting an industry standard for training and/or application, such as a bookkeeper having specific behaviours, for example. Thus, according to one particular example, in a desktop environment, the CEO's dashboard on their desktop user may be able to compare individuals or user groups to track progress or monitor at a high level their performance against the benchmark score and highlight users above or below this median average.

Furthermore, the system and method described herein can also integrate into social media platforms and allow the users to create their own social user groups as well as loading generic role specific behaviours into their profile. They can also “invite” a supervisor or manager to join him or her in the system/method for validation purposes even if the business is not a user. If that manager would like to increase users or view the dashboard they would have to join the system in the manner described above. Thus, many advantages can be provided by the system and method for monitoring behaviour, including but not limited to providing a system/method in which there can be provided:
Minimal or no training required
Accessibility (Smartphone or Web)
A broad user demographic (corporate & personal)
Purchasable add-ons (Health & Wellbeing etc)
Global sales potential
Increased ROI on Training
Measurable training retention
Real-time visibility
Enhanced productivity, efficiency & revenue
Increased Accountability
Cost Effective (Licensed)
Scalable system components
Leveraging of existing platform investments

FIG. 7 shows an example of a distributed system architecture implementing the system of FIG. 2. In this example, software is stored in nonvolatile memory 700 in the form of FLASH, but could be stored in a hard drive, EPROM or any other form of tangible media within or external to each of the computing/processing systems of the first user 205, second user 206, third user 207, etc., and the main processing system 210. The software generally, but not necessarily, comprises a plurality of software modules that cooperate when installed on each of the computing/processing systems. Functions, or components for example, may be compartmentalized into software and/or hardware modules or may be fragmented across several software and/or hardware modules. The software modules may be formed using any suitable language, examples of which include C++, JAVA and assembly. The program may take the form of an application program interface or any other suitable software structure. Each of the plurality of computing/processing systems of the first user 205, second user 206, third user 207, etc., and the main processing system 210 includes a suitable microprocessor 720 (for example an Intel, ARM or AMD processor) connected by a bus 740 to random access memory 760 of around 2 GB and non-volatile memory for example a hard disk drive 780 or solid state non-volatile memory having a capacity of around 100 GB. Each of the plurality of computing/processing systems of the first user 205, second user 206, third user 207, etc., and the main processing system 210 has input/output interfaces 710 which may include one or more network interfaces (for interfacing with network 215) in the form of, for example, a network interface card, and a universal serial bus. The computing/processing systems of the first user 205, second user 206, third user 207, etc., and the main processing system 210 may also each support a human machine interface 730 (e.g. mouse, keyboard, display, trackpad, touchscreen etc), and the components 700-780 communicate via the bus 740. Generally but not necessarily, the computing/processing systems of the first user 205, second user 206, third user 207, etc., and the main processing system 210 can be any form of processing systems including but not limited to a desktop system, a laptop, tablet or mobile telecommunication device with or without their own data stores and with or without access to external data stores 220.

### Example Attributes

The following provides examples of attributes that can form the basis of behaviours including tasks to be completed in accordance with associated predetermined criteria, and also different levels of performance of completion of the tasks in addition to the described predetermined threshold values of receipt on the validations for a given period of time.

Attribute 1: COMMUNICATION

Level A: Communicates persuasively with senior members of the business, the relevant Committees, and with people at all levels both within and outside of the organisation.

Positive indicators
Develops communication strategies and mechanisms which ensure that important messages are cascaded in a consistent, clear and timely way internally and externally as appropriate.
Presents verbal and written proposals and updates to senior managers & stakeholders within the business
Disseminates and explains management decisions and policy and the reasons behind them to those at all levels of the business.
Communicates a compelling view of the strategy which provides direction for the business
Responds convincingly and authoritatively to questions and concerns in particular from senior management colleagues

Level B: Communicates effectively and appropriately with senior management, external partners and with people at all levels both within and outside of the organisation.

Positive indicators
Explains complex issues, in a way that is easy to understand.
Works collaboratively with senior management to ensure that consistent messages are cascaded appropriately.
Prepares communications for and on behalf of senior members of the Business.
Produces well-structured reports and written summaries.
Ensures that important messages are being communicated and understood within the Business and outside the Business as appropriate.
Communicates fluently and persuasively as required.
Delivers difficult messages sensitively.

Level C: Communicates effectively and appropriately with a variety of stakeholders including external partners, teams, colleagues and contacts.

Positive indicators
Communicates clearly and concisely both orally and in written documents
Recognises the need to adapt style and delivery according to the situation.
Supports arguments and recommendations effectively.
Ensures that important messages are communicated within the Institution.
Shares information as appropriate and checks understanding.
Ensures that communication has a clear purpose.
Responds constructively and effectively to questions and comments.

Level D: Communicates effectively with colleagues and contacts

Positive indicators
Communicates in a way that is understandable and meaningful to everyone
Listens carefully and asks questions to clarify own understanding
Ensures that communication is factual, accurate and timely
Communicates information using appropriate methods

Attribute 2: RELATIONSHIP BUILDING

Level A: Builds and manages mutually beneficial partnerships and networks, both internally and externally, to create opportunities for the business. Works effectively with senior management colleagues and seeks opportunities for enhancing the effectiveness of teams.

Positive indicators
Builds and maintains close working relationships with senior members of the Business to act in the interests of the Business as a whole
Engages stakeholders and agrees appropriate action plans.
Anticipates and identifies ways in which the Business can collaborate with partners to address current and future challenges, providing the structures and processes to enable this.
Maintains and draws upon a network of contacts in influential or specialist positions.
Provides active support to own management team, ensuring that they have the information they need to make decisions.
Identifies overlaps of activity within the Business and opportunities for synergies across institutions.
Focuses team building on achieving high performance.
Actively engages and supports teams within own area of responsibility.

Level B: Develops and maintains existing partnerships. Builds teams and identifies means of enhancing their effectiveness.

Positive indicators
Engages with stakeholders to conduct joint working activity, to agree and action complex issues.
Understands the links between the Businesses work and that of partners, using this knowledge to inform own work.
Identifies opportunities for leveraging existing partnerships or developing new ones that will support the work of both organisations.
Sets up teams or working groups and involves them in achieving goals.
Works inside and outside own team to share ideas and information where appropriate.
Visibly assists their team to remove barriers, particularly in the face of complex tasks or high demands.
Identifies common goals and interests, and uses these to unite teams
Gains commitment from others by consulting and involving them.
Understands relationships within the team and the way that different team members work together.

Level C: Maintains working relationships with existing partners. Works effectively within a team or work group as appropriate.

Positive indicators
Seeks to understand the key priorities of stakeholders and gain their commitment through consultation and involvement
Shows interest in team members and is aware of their needs and circumstances.
Develops good relationships and cooperation within the team and with other colleagues
Actively promotes the interest of the Business within partnerships and networks
Ensures that colleagues, prospects and internal and external contacts are satisfied with assistance that they receive.
Actively seeks the ideas and suggestions of others
Focuses on contribution to team performance and recognises that of others.

Level D: Deals with colleagues, students and internal and external contacts in a professional manner. Works effectively within a team or other work group as appropriate.

Positive indicators
Understands own role within the team.
Works effectively as a team member and builds relationships with colleagues.
Actively supports and assists colleagues to reach individual and team objectives
Acknowledges that there is sometimes a need to help and support a wider team.
Responds quickly and effectively to requests from colleagues, students and internal and external contacts managing their expectations and keeping them updated on progress.

Attribute 3: VALUING DIVERSITY

Level A: Considers and respects the ideas, circumstances and feelings of others. Treats everyone with fairness and respect, adhering to the principles of diversity and inclusion.

Positive indicators
Promotes an inclusive environment which values equality of opportunity and diversity
Role models the highest standards of behaviour.
Challenges or reports inappropriate attitudes, language and behaviour that is abusive, aggressive or discriminatory
Acknowledges and respects a broad range of social and cultural customs, beliefs and values within the law
Demonstrates mutual respect tolerance and integrity
Listens to and respects others' views and opinions

Attribute 4: ACHIEVING RESULTS

Level A: Demonstrates a willingness to take difficult strategic decisions and an ability to resolve complex problems. Provides direction on how to manage conflicting priorities and tensions.

Positive indicators
Makes decisions by logically evaluating all relevant factors and applying a range of analytical techniques
Gathers information and ideas from external sources to benefit the Business
Considers the impact on the Business as a whole when taking difficult decisions
Sets stretching performance standards and measures which align with strategic objectives
Creates a performance culture in which activity is continuously reviewed and improved
Takes ownership for the work within the institution to deliver on time, within budget and agreed quality standards
Provides assurance to the most senior members of the Business on performance and achievement against the Business's priorities
Analyses financial and statistical data to identify the Business's strategic progress and priorities
Considers complex or conflicting data and different perspectives before making a decision on the way forward
Makes and sees through sensitive, unpopular or controversial decisions
Takes calculated risks and develops an approach for mitigating risk

Level B: Identifies and manages important issues and problems effectively. Plans and monitors the work of others and takes accountability for their levels of performance and success. N.B. Some elements of the positive indicators may not apply to roles that do not have line management responsibility.

Positive indicators
Makes decisions following careful analysis of the issue and by challenging assumptions to ensure that information is accurate.
Produces effective responses in difficult situations and resists pressure to make quick decisions where full consideration is needed.
Develops strategies for overcoming barriers and seeks opportunities for early resolution of issues.
Promotes the importance of identifying and managing risk.
Sets clear goals and milestones, establishing importance and urgency.
Provides clear direction and ensures that staff know what is expected of them.
Demonstrates measurable individual and team progress against relevant institution goals.
Identifies performance issues within area of responsibility and establishes interventions to ensure delivery to plan and targets.

Level C: Solves work-related problems effectively. Provides support and contributes to the performance of the institution. Manages own workload and, where applicable, the workload of others.

Positive indicators
Systematically gathers information from a range of sources before reaching conclusions on necessary action.
Checks consistency of information to ensure that it is correct and has not been misunderstood.
Makes decisions using as much reliable information as possible.
Conducts research to identify relevant facts that are not immediately available and gathers different versions of events to build a full picture.
Identifies elements of a problem that can and cannot be changed.
Refers to policies and procedures as necessary before taking action.
Shows an ability to identify risk and consider its potential impact on the Business.
Is willing to take on responsibility to overcome obstacles and ensure delivery of targets.
Takes responsibility for own performance and their contribution to team achievement.

Level D: Gathers information to understand problems and issues, making recommendations and/or taking action as appropriate. Manages own workload effectively.

Positive indicators
Takes in information quickly and accurately.
Identifies where to get information when trying to solve a problem.
Gathers sufficient information to understand issues fully, and consults those with relevant knowledge.
Reviews all the information gathered to understand the situation and draw logical conclusions.
Is confident to use initiative where appropriate.
Resolves issues at an early stage before they become significant.
Remains impartial and avoids making assumptions.
Contributes effectively to institutional performance.
Acts positively and with determination when under pressure

Attribute 5: STRATEGIC FOCUS

Level A: Drives the strategic priorities of the Business and inspires a shared vision for its future direction.

Positive indicators
Promotes the Business's mission and goals, developing strategies to drive their achievement.
Monitors developments within the external environment and plans for their impact on the work of the Business.
Takes an organisational view, thinking beyond the interests of own specialism/area.
Identifies and successfully manages complex political agendas within the governance structure.
Compares performance with other Businesses and centres of excellence to inform objectives and priorities.
Develops ways of working that balance the needs of individual departments and the business.

Level B: Takes a strategic view and creates long-term plans for the institution/area of responsibility. Promotes a shared vision for the Business.

Positive indicators
Shows an awareness of political, economic and legislative trends and their effect on the Business.
Creates a vision for the future which supports the aims and objectives of the Business.
Formulates plans which translate strategy into action.
Thinks beyond own specialist area or function, understanding the impact of actions on other areas of the Business.
Works to influence the Business's strategy, direction and culture to increase effectiveness for the future.
Considers long-term issues, even when having to respond to changing circumstances

Level C: Implements the Business strategy and planning activity within the team. Supports the Businesses mission and priorities.

Positive indicators
Demonstrates knowledge of the Business 's strategy and concentrates on matters that support its achievement.
Ensures that own way of working is in line with the strategic direction of the Business.
Understands the main issues that affect the Business.
Raises awareness of strategic issues with colleagues.
Supports and co-operates with Business policy and procedures.
Recognises the links between related activities.
Acts in the best interests of the Business rather than self-interest

Level D: Demonstrates awareness of the Business direction; understands and supports its mission

Positive indicators
Understands and supports what the Business is working to achieve.
Understands what other areas of the Business do and where to get information.
Understands how own role contributes to the goals of the Business.
Thinks through the wider consequences of own actions.
Co-operates with Business policy and procedures

Attribute 6: PEOPLE DEVELOPMENT

Level A: Creates an environment where people are motivated to achieve Business objectives and enhance their own performance. Puts systems and strategies in place to develop people at all levels across the Business and identifies opportunities to increase organisational capability and capacity through people.

Positive indicators
Develops senior management capability in line with the Business's mission and priorities.
Creates opportunities for maximising the potential of senior management and building the Business's leadership capability.
Leads the effective cascade of Business and institution objectives and enables individuals to recognise their contribution in achieving these.
Provides staff with a sense of purpose and direction.
Improves Business capability, capacity, reputation and impact through effective people management.
Promotes commitment to the Business's mission and behaviours.
Promotes and demonstrates the effective use of the Staff Review and Development Scheme and effective people practices.
Supports and encourages use of the services of the Centre for Personal and Professional Development.
Seeks and acts on feedback of own performance and management style

Level B: Encourages and facilitates the learning and development of others. Demonstrates enhancement of individual and team potential through giving clear direction, guidance and feedback on performance. N.B. Some elements of the positive indicators may not apply to roles that do not have line management responsibility.

Positive indicators
Demonstrates understanding of the talents, capabilities and needs of staff and matches these to development opportunities.
Provides opportunities for staff to learn and progress their careers, providing advice and guidance where appropriate.
Creates an environment where staff are clear on what is expected of them and are motivated to achieve results.
Fairly and accurately assesses performance using the Staff Review and Development Scheme, giving constructive and developmental feedback.
Manages performance shortfalls in a timely and supportive manner.
Helps people identify and develop their strengths and development needs.
Shares knowledge with staff and creates opportunities for coaching and mentoring.
Encourages staff to see the development opportunities in everyday activities and manages their development expectations.
Supports and encourages use of the services of the Centre for Personal and Professional Development.

Level C: Demonstrates effective people management skills. Promotes and facilitates the development of others. N.B. Some elements of the positive indicators may not apply to roles that do not have line management responsibility.

Positive indicators
Encourages staff to learn and develop, giving them advice where necessary.
Manages performance effectively using the Staff Review and Development Scheme.
Assists staff in developing their skills through encouragement, motivation and support.
Encourages staff to achieve and support the Business's aims.
Makes sure people know what a task or responsibility involves and that they have the necessary abilities to carry it out.
Identifies and addresses the training needs of staff.
Involves staff in new areas of work and decision making to enhance their knowledge and skills.
Supports and encourages use of the services of the Centre for Personal and Professional Development.

Level D: Takes ownership of own performance and development. Assists and supports the development of others.

Positive indicators
Offers and provides guidance, support, induction and training to colleagues.
Sets high performance standards for self.
Seeks opportunities to improve own job related knowledge.
Takes ownership for personal development.
Makes proactive use of the services of the Centre for Personal and Professional Development.
Participates fully in the Staff Review and Development Scheme.
Acts upon feedback of own performance

Attribute 7: NEGOTIATING AND INFLUENCING

Level A: Develops sophisticated strategies for influencing the most senior members of the Business using logic, reason and persuasive arguments. Effectively reconciles divergent interests.

Positive indicators
Identifies legitimate interests and key players before commencing negotiation.
Involves and engages internal and external contacts to enhance the effectiveness of proposals and to build support.
Anticipates the reactions of key stakeholders and develops negotiation strategies for responding to these effectively.
Focuses on important elements of complicated issues to promote the benefits of a proposal to others.
Demonstrates awareness of the working relationships between individuals, groups and institutions and how these change over time.
Balances conflicting priorities and agendas by achieving acceptable solutions, without damage to long-term relationships.

Level B: Negotiates and influences at senior management level using persuasive arguments. Identifies clear aims in negotiations and achieves satisfactory outcomes.

Positive indicators
Successfully persuades and influences at senior management level through building support amongst colleagues and considers the reactions of stakeholders.
Negotiates satisfactory solutions on broad or complicated issues with stakeholders.
Gains support before presenting proposals.
Involves people who have positive attitudes to help secure the commitment of others.
Prepares ideal, realistic and fall-back positions.
Anticipates possible issues, objections and consequences

Level C: Persuades and influences peers and managers through consideration of their interests, involvement and consultation.

Positive indicators
Canvasses opinion and builds support amongst colleagues.
Promotes the benefits of a decision or situation to others.
Identifies clear aims in negotiations and achieves satisfactory outcomes.
Handles objections by acknowledging issues and suggesting alternatives.
Ensures that everyone involved is satisfied with agreements that have been reached.

Shows willingness to compromise where appropriate to achieve an acceptable solution.

Level D: Persuades and influences colleagues through involvement and consultation

Positive indicators
Seeks, considers and understands alternative opinions.
Shows willingness to accommodate the needs of others.
Thinks through possible issues and raises these as appropriate.
Clearly explains the reasons behind actions.

Attribute 8: INNOVATION AND CHANGE

Level A: Fosters a culture of innovation to build the Business's capability. Identifies and champions new approaches for improving organisational results and achievement.

Positive indicators
Tackles strategic challenges with resourcefulness and creative solutions.
Draws on ideas and information from external organisations and networks to improve organisational outcomes.
Ensures that senior managers are responsible for capturing and disseminating learning and knowledge.
Builds capability by promoting the development of new techniques.
Drives innovation within institution.
Encourages and supports managers to take responsibility for innovation and change.
Identifies areas within the Business that need to be changed.
Demonstrates a personal belief in and commitment to change.
Assesses the likely benefit and effect of change before initiating it.
Encourages people to question methods and propose more effective alternatives

Level B: Supports, promotes and implements change. Encourages the adoption of new methods and overcomes barriers to acceptance. N.B. Some elements of the positive indicators may not apply to roles that do not have line management responsibility.

Positive indicators
Explores new and innovative ways of working and drives innovation within own area.
Introduces new ways of working and overcomes resistance through involving people and demonstrating the benefits.
Encourages staff to identify improvements to systems and services and to take these forward.
Communicates the desire for the institution to succeed through original thinking.
Draws on networks to identify new methods and techniques.
Identifies people with the ability to accept change and supports those who find it difficult to adapt.
Demonstrates understanding of people's fear of change

Level C: Develops and promotes new ways of working to improve performance within team and Business.

Positive indicators
Identifies areas of good practice and shares successes which may improve ways of working across the institution.
Considers new approaches or solutions to problems and demonstrates taking these forward.
Develops innovative techniques within own professional field.
Keeps abreast of new developments and initiatives outside the Business.
Encourages colleagues to respond quickly and positively to change.
Recognises potential barriers to change and ways in which these might be minimised.

Level D: Understands the need for change, demonstrates flexibility and is willing to try new approaches

Positive indicators
Proposes new ideas in relation to own work.
Supports new ideas and initiatives with enthusiasm.
Contributes to innovative ideas within own team.
Seeks to improve and update knowledge.
Demonstrates willingness to try unfamiliar tasks.

### Example Behaviour Developments

Examples of various behaviour developments for specific roles in an organisation are provided below:

An example of tasks which can be performed and monitored for a bookkeeper role are provided below in Table 1:

TABLE 1

| | | | | | Manager/Supervisor |
|---|---|---|---|---|---|
| Behaviours/Responses | Daily | Weekly | Other | Comments | Action or response |
| Complete & upload | | Y/N | | Time loaded | Action Complete - |
| cash flow analysis by | | | | | validation sent (Green) |
| 10am Mondays | | | | | |
| Complete & Upload | Y/N | | | Time loaded | See comments & re- |
| End of Day checklist | | | | | submit (Amber) |
| Submit Issues/Queries | Y/NA | | | | |
| from Daily checklist | | | | | |
| for review | | | | | |
| Submit role specific | | Y/N | | Time stamp | Action Complete - |
| weekly learning | | | | | validation sent (Green) |
| Submit generic | | Y/N | | Time stamp | Action Required |
| company/alternate | | | | | (Red) |
| role weekly learning | | | | | |
| Quarterly events | | | Y/N | Date specific | |
| confirmation list | | | | | |
| Annual events | | | Y/N | Date specific | |
| confirmation List | | | | | |
| Give an example of | | Y/N | | Time stamp | Action Complete - |
| using your Initiative | | | | | validation sent (Green) |
| Give an Example of | | Y/N | | Time stamp | Action Complete - |
| collaboration | | | | | validation sent (Green) |

An example of tasks which can be performed for a sales role are provided below in Table 2:

TABLE 2

| | | | | | Manager/Supervisor |
|---|---|---|---|---|---|
| Behaviours/Responses | Daily | Weekly | Other | Comments | Action or response |
| Complete & upload week | | Y/N | | Time loaded | See comments & re- |
| planner by 10am Mondays | | | | | submit (Amber) |
| Complete & Upload | Y/N | | | Time loaded | Action Required |
| meeting planner | | | | | (Red) |
| document | | | | | |
| Submit Activity | | | Y/NA | Time loaded | Action Complete - |
| Development Plan | | | | | validation sent |
| | | | | | (Green) |
| Post Meeting Opportunity | | Y/N | | Time loaded | Action Complete - |
| Report | | | | | validation sent |
| | | | | | (Green) |
| Post Meeting Customer | Y/N | | | | Action Complete - |
| Learnings Proof | | | | | validation sent |
| | | | | | (Green) |
| Submit & upload sales | | | | | See comments & re- |
| forecast for review | | | | | submit (Amber) |
| Monthly Sales Against | | | Y/N | Date specific | See comments & re- |
| forecast | | | | | submit (Amber) |
| Coaching Observations of | | | Y/N | Date specific | Action Complete - |
| Manager/Supervisor | | | | | validation sent |
| | | | | | (Green) |
| Give an example of using | | Y/N | | Time stamp | Action Complete - |
| your initiative | | | | | validation sent |
| | | | | | (Green) |
| Give an example of | | Y/N | | Time stamp | Action Required |
| collaboration | | | | | (Red) |

An example of tasks which can be performed for a production role are provided below in Table 3:

TABLE 3

| | | | Manager/Supervisor |
|---|---|---|---|
| Behaviours/Respones | Daily | Comments | Action or response |
| Machinery & Materials | Y/N | Time loaded | See comments & re- |
| Pre job Check | | & GPS | submit (Amber) |
| OHS Compliance Check | Y/N | Time loaded | Action Required |
| | | & GPS | (Red) |
| Job Commencement | Y/N | Time loaded | Action Complete - |
| Sheet | | | validation sent |
| | | | (Green) |
| In Job QA Inspection & | Y/N | Time loaded | See comments & re- |
| Approval | | & GPS | submit (Amber) |
| Post job Admin & Sign | Y/N | Time loaded | Action Complete - |
| off | | | validation sent |
| | | | (Green) |
| Post Job Materials & | Y/N | Time loaded | Action Complete - |
| Tools Cleanup | | & GPS | validation sent |
| | | | (Green) |
| Systems Update & | Y/N | | See comments & re- |
| cross check | | | submit (Amber) |
| Post job Audit | Y/N | Date & Time | See comments & re- |
| completed | | stamp | submit (Amber) |
| Coaching Observations | | Date specific | Action Complete - |
| of Manager/Supervisor | | | validation sent |
| | | | (Green) |
| | | | This could be escalated |
| | | | up the chain if not |
| | | | agreed by line manager |
| Give an example of | Y/N | | See comments & re- |
| using your initiative | | | submit (Amber) |
| Give an example of | Y/N | | Action Complete - |
| collaboration | | | validation sent |
| | | | (Green) |

Those of skill in the art will appreciate that numerous modifications or changes can be made to the particular embodiment described above without departing from the scope of the invention. All such modifications and changes are intended to be included within the scope of the appended claims

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method of monitoring behaviour of a first user in a group of users, the behaviour including the first user completing one or more tasks over time in accordance with one or more predetermined criteria associated therewith, the method including:
receiving, at a main processing system, evidentiary information that the one or more tasks have been completed by the first user from a first user processing system associated with the first user in data communication with the main processing system;
the main processing system sending a notification to a second user in the group of users, having a second user processing system in data communication with the main processing system, that the one or more tasks have been completed by the first user;
the second user providing a validation that the one or more tasks have been completed in accordance with the one or more predetermined criteria associated therewith based on the evidentiary information;
receiving the validation from the second user processing system; and
the main processing system providing an indication of the behaviour for display on respective selected user interfaces of the group of the users including the first user based on ones of the validation that the one or more tasks have been completed by the first user over time.

2. A method of claim 1, wherein the indication of said behaviour includes display of a plurality of levels, each of the levels indicating a predetermined threshold value of receipt of said ones of the validation for a given period of time.

3. A method of claim 2, further including:
providing a weighting for said ones of the validation based on the one or more tasks that have been completed, wherein each of the plurality of levels indicate the predetermined threshold value of receipt of said ones of the validation for the given period of time according to the weighting of said ones of the validation, respectively.

4. A method of claim 3, further including:
determining, at the main processing system, a score for the behaviour of the first user indicative of receipt of said ones of the validation over the given period of time according to the weighting of said ones of the validation, respectively, and providing the score for display to the group of users on said respective selected user interfaces.

5. A method of claim 4, further including:
providing a benchmark score for display to the group of users on said respective selected user interfaces in association with the score.

6. A method of claim 1, wherein the indication for display on a user interface of the first user further includes display of a plurality of colours indicating a status of the validation.

7. A method of claim 6, wherein the status includes: validated, not-validated, and redo the one or more tasks based on provided comments.

8. A method of claim 1, wherein the indication further includes display of a graph indicating receipt of said ones of the validation that the one or more tasks have been completed by the first user for a given period of time, over time.

9. A method of claim 1, wherein the indication further includes display of a graph indicating receipt of said ones of the validation that the one or more tasks have been completed by the first user compared with ones of the notification sent to the second user that the one or more tasks have been completed by the first user.

10. The method of claim 1, further including:
the main processing system sending a notification to a third user in the group of users having a third user processing system in data communication with the main processing system that the one or more tasks have been completed and have been validated by the second user;
the third user providing a non-validation if the one or more tasks have not been completed in accordance with the one or more predetermined criteria based on the evidentiary information;
receiving the non-validation from the third user processing system; and
updating the indication of the behaviour based on ones of the non-validation that the one or more tasks have not been completed by the first user over time.

11. The method of claim 1, wherein the first user is an employee in the group of users, the second user is a manager of the employee in the group of users or a customer of the employee in the group of users.

12. The method of claim 11, wherein the behaviour is a requirement of a role of the employee and the predetermined criteria is predetermined according to the role of the employee.

13. The method of claim 11, wherein providing said indication of the behaviour for display on a user interface of the manager includes providing ones of the indication of the behaviour of ones of the employee in the group of users over time.

14. The method of claim 1, further including:
determining, at the main processing system, a time taken between sending the notification to the second user processing system and receiving the validation from the second user processing system; and
providing an indication of the time taken for display on a user interface of a third user in the group of users having a third user processing system in data communication with the main processing system.

15. The method of claim 1, wherein the evidentiary information includes any one or a combination of:
a time stamp, indicating a time of completion of the one or more tasks;
one or more documents; and
location information, indicating a location of the one or more tasks.

16. The method of any one of claim 1, further including:
verifying, at the main processing system, that the one or more tasks have been completed in accordance with the one or more predetermined criteria based on the evidentiary information;
providing a verification that the one or more tasks have been completed; and
the main processing system sending the notification to the second user upon verification that the one or more tasks have been completed.

17. The method of claim 1, further including:
the main processing system sending the notification to a third user in the group of users if the main processing system does not receive the validation from the second user processing system within a predetermined time.

18. The method of claim 17, further including:
the main processing system providing a non-validation that the one or more tasks have not been completed by the first user if the second user and the third user do not provide validations in a predetermined time, respectively.

19. A system for monitoring behaviour of a first user in a group of users, the behaviour including the first user completing one or more tasks over time in accordance with one or more predetermined criteria associated therewith, the system including:
a first user processing system associated with the first user;
a second user processing system associated with a second user in the group of users; and
a main processing system in data communication with the first user processing system and the second user processing system over a network, wherein the main processing system is configured to:
receive evidentiary information that the one or more tasks have been completed by the first user from the first user processing system;
send a notification to the second user that the one or more tasks have been completed by the first user and the second user providing a validation that the one or more tasks have been completed in accordance with the one or more predetermined criteria associated therewith based on the evidentiary information;
receive the validation from the second user processing system; and
provide an indication of the behaviour for display on respective selected user interfaces of the group of the users including the first user based on ones of the validation that the one or more tasks have been completed by the first user over time.

20. A system of claim 19, wherein the indication of the behaviour is displayed on a first user interface of the first user processing system.

21. A system of claim 19, wherein the system further includes a third user processing system associated with a third user in the group of users in data communication with the main processing system, and the indication of the behaviour is displayed on a third user interface of the third user processing system.

22. A main processing system for monitoring behaviour of a first user in a group of users, the behaviour including the first user completing one or more tasks over time in accordance with one or more predetermined criteria associated therewith, the main processing system including:
a processor;
a data store including computer program code to be performed by the processor; and
a network interface for interfacing with a plurality of user processing systems associated with respective users in the group of users over a network, wherein the processor is configured to:
receive evidentiary information that the one or more tasks have been completed by the first user from a first user processing system associated with the first user in data communication with the main processing system over the network;
send a notification to a second user in the group of users, having a second user processing system in data communication with the main processing system over the network, that the one or more tasks have been completed by the first user and the second user providing a validation that the one or more tasks have been completed in accordance with the one or more predetermined criteria associated therewith based on the evidentiary information;
receive the validation from the second user processing system over the network; and
provide an indication of the behaviour for display on respective selected user interfaces of the group of the users including the first user based on ones of the validation that the one or more tasks have been completed by the first user over time.

23. (canceled)
